(19) United States
(12) Patent Application Publication
(10) Pub. No.: US 2004/0074054 A1
(43) Pub. Date: Apr. 22, 2004

(54) Cable band

(76) Inventor: Kyung-Jin Park, Busan-City (KR)

Correspondence Address: LADAS & PARRY, 224 SOUTH MICHIGAN AVENUE, SUITE 1200, CHICAGO, IL, 60604, US

(21) Appl. No.: 10/468,251

(22) PCT Filed: May 24, 2002
(86) PCT No.: PCT/KR02/00990

(30) Foreign Application Priority Data
Jul. 5, 2001 (KR) 2001/20309 U

(51) Int. Cl. F16L 33/00

(52) U.S. Cl. 24/25

(57) ABSTRACT

This device relates to an intensively improved cable band, especially to a cable band capable of unclipping the clipped band at any time. Tapered type steel ball injection hole (5) is formed to the clip portion (3) by inclinational projection (4) at the end of the band (2) with a predetermined length, and wherein steel ball (6) is inserted inside so that the band (2) is clipped, typical metal cable band (1) configured above makes it possible to easily unclip and reuse the cable band (1) by forming a cut hole (7) longitudinally in the inclinational projection (4) of the clip portion (3) so as to move the steel ball (6).

### FIELD OF THE INVENTION

This device relates to an intensively improved cable band, especially to the device capable of unclipping the clipped band and reusing it at any time.

### BACKGROUND OF THE INVENTION

Various kinds of cable band using stainless steel or plastics such as polypropylene have been typically used in the art so as to have several piping materials or cables on more than one specific position or to have the objects fixed. But, in case of the above mentioned conventional cable band, these should be cut when needed after clipped once, so that these can not be used again, thereby consuming high price materials in the case of cable bands with metal like stainless steel, and leading to the need of improved cable band capable of being reused in the art.

### SUMMARY OF THE INVENTION

The present device relates to a novel cable band capable of solving problems which conventional cable band with metal like stainless steel had, more particular, to a device capable of reusing the cable band by unclipping the band clipped to the clip object with an appropriate tension.

### BRIEF DESCRIPTION OF THE DRAWINGS

The nature and mode of operation of preferred embodiments of the present device will be more fully described in the following detailed description, taken with the accompanying drawings wherein:

FIG. 1 is a cross-sectional view showing the usage of conventional cable band.

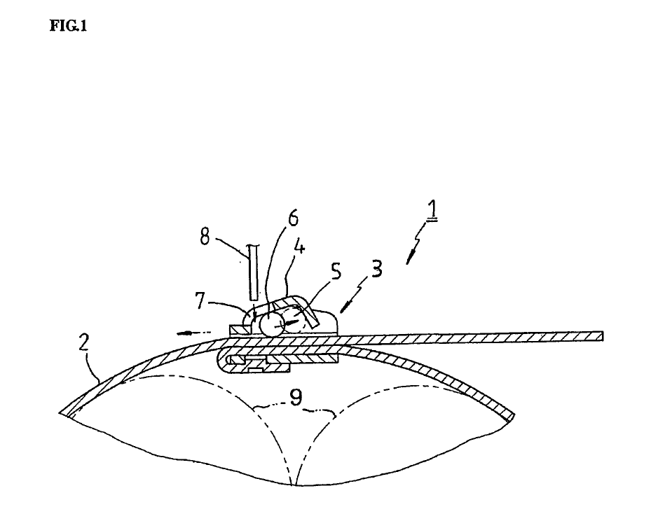

FIG. 2 is a perspective view showing on preferred embodiment of the present device.

FIG. 3 is a cross-sectional view showing the usage of the present device.

### DETAILED DESCRIPTION OF THE PREFERRED EMBODIMENTS

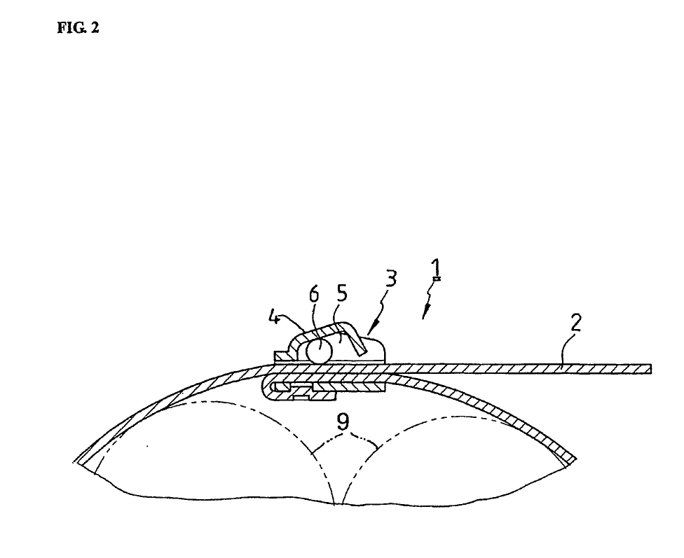

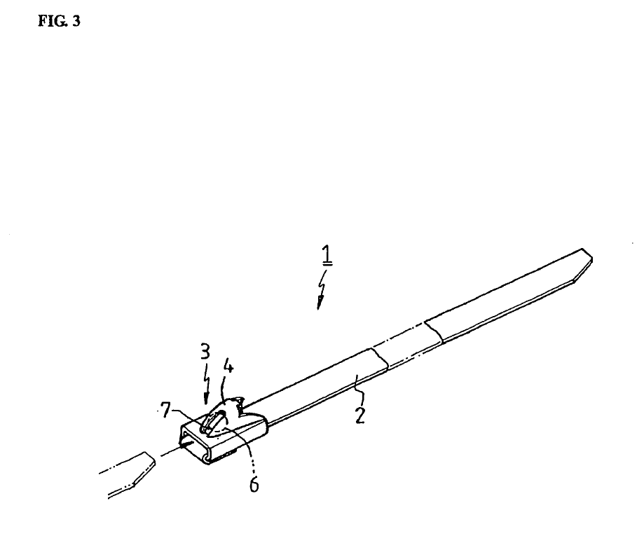

FIG. 2 is a perspective view showing on preferred embodiment of the present device, and FIG. 3 is a cross-sectional view showing the usage of the present device, and detailed description are described below taken with the accompanying drawings.

This device is an intensively improved cable band, especially relates to a cable band capable of unclipping the clipped band at any time. Tapered type steel ball injection hole (5) is formed to the clip portion (3) by inclinational projection (4) at the end of the band (2) with a predetermined length, and wherein steel ball (6) is inserted inside so that the band (2) is clipped, typical metal cable band (1) configured above makes it possible to easily unclip and reuse the cable band (1) by forming a cut hole (7) longitudinally in the inclinational projection (4) of the clip portion (3) so as to move the steel ball (6) inserted by the tool (8) like small sized pin. Numerical note 9 represents the fixing object by the cable band (1) of the present device.

The above device is used when to fix the various fixing objects, and the fixing object (9) is encircled by the band (2) like the typical band (1) and the one end of the object is fixed into the clip portion (3) and pushed to the fixing direction, thereby completing the fixing operation.

Band (2) fixed to the clip portion (3) is clipped like that when it is pushed to the fixing direction, steel ball (6) moves to the fixing direction, or the larger space direction of the Tapered type steel ball injection hole (5) formed by the inclinational projection (4), and when it is in a state of clipping, steel ball (6) moves to the narrow direction and fixes the band (2) tightly. According to the present device, cut hole (7) is formed longitudinally at the inclinational projection (4), so when needed to unclip the cable band (1) which has been clipped in accordance with the above operation, tool (8) like small sized driver or pin is inserted to the cut hole (7) formed longitudinally at the inclinational projection (4) and then steel ball (6) is moved to the fixing direction, thereby unclipping operation is completed. This make it possible to solve the problem of cutting the cable band (1) occurred in the prior art.

### INDUSTRIAL APPLICABILITY

Metal used cable band (1) has a configuration that the cut hole (7) is formed longitudinally at the inclinational projection (4), and when needed to unclip the band for maintenance after clipping, it can be easily unclipped by tools like small sized driver, thereby can not only use the cable band (1) again but gain several advantages like user-convenience, saving materials etc.

What is claimed:

1. Metal used cable band (1) configured to fix the clip portion (3) having the tapered type steel ball injection hole (5) formed by the inclinational projection (4), wherein the steel ball (6) is inserted so as to clip the band (2) thereto,
Characterized in that the Cut hole (7) is formed longitudinally at the inclinational projection (4) of said clip portion (3) so as to move the steel ball (6).
